(19) United States
(12) Patent Application Publication
(10) Pub. No.: US 2011/0114239 A1
(43) Pub. Date: May 19, 2011

(54) HEAVY DUTY TIRE

(76) Inventors: Gayathri Venkataramani, Masfield, OH (US); Mohamad Afif Bachir, Medina, OH (US); Dale Eugene Wells, Massillon, OH (US)

(21) Appl. No.: 12/618,064

(22) Filed: Nov. 13, 2009

(51) Int. Cl. B60C 15/00

(52) U.S. Cl. 152/539

(57) ABSTRACT

A pneumatic tire construction is described suitable for severe loading conditions. The tire includes a bead portion further having an apex which extends radially outward of the bead core, and a first turnup pad located adjacent said chafer, and a second turnup pad located adjacent said first turnup pad, wherein the first turnup pad has a G′ less than the G′ of the second turnup pad. Alternatively, the first turnup pad may be located adjacent to the rim flange and the second turnup pad may be located axially inward of the first pad. The second turnup pad is preferably thicker and longer than the first turnup pad.

### TECHNICAL FIELD

This invention relates to heavy duty pneumatic tires such as are commonly used on earthmoving equipment, aircraft, and agricultural tires.

### BACKGROUND

The invention concerns the reduction of rim chafing in Off-The-Road tires of radial construction that are used in heavily loaded vehicles. The lower sidewall of a typical radial OTR construction consists of a ply around the bead and chipper reinforcements that restrict the circumferential deformation of the ply. Under the action of loads, the lower sidewall of the tire bends over the rim flange, and the ply reinforcement rotates in the circumferential direction. The two modes of deformation result in rubbing of the chafer against the rim flange resulting in wear of both the tire and rim. Chafing can be minimized by using reinforcements in the lower sidewall, but this reduction is not very significant. Thus it is desired to have an improved tire design to reduce the rim chafing of the tire against the rim.

### DISCLOSURE OF THE INVENTION

### Definitions

“Aspect ratio” of the tire means the ratio of its section height (SH) to its section width (SW);

“Axial” and “axially” mean lines or directions that are parallel to the axis of rotation of the tire;

“Bead” means that part of the tire comprising an annular tensile member wrapped by ply cords and shaped, with or without other reinforcement elements such as flippers, chippers, apexes, toe guards and chafers, to fit the design rim;

“Belt reinforcing structure” means at least two layers of plies of parallel cords, woven or unwoven, underlying the tread, unanchored to the bead, and having both left and right cord angles in the range from 17 degrees to 27 degrees with respect to the equatorial plane of the tire;

“Bias Ply Tire” means that the reinforcing cords in the carcass ply extend diagonally across the tire from bead-to-bead at about a 25-50° angle with respect to the equatorial plane of the tire, the ply cords running at opposite angles in alternate layers;

“Carcass” means the tire structure apart from the belt structure, tread, under tread, and sidewall rubber over the plies, but including the beads;

“Circumferential” means lines or directions extending along the perimeter of the surface of the annular tread perpendicular to the axial direction;

“Chafers” refers to narrow strips of material placed around the outside of the bead to protect cord plies from the rim, distribute flexing above the rim, and to seal the tire;

“Chippers” means a reinforcement structure located in the bead portion of the tire;

“Cord” means one of the reinforcement strands of which the plies in the tire are comprised;

“Design rim” means a rim having a specified configuration and width. For the purposes of this specification, the design rim and design rim width are as specified by the industry standards in effect in the location in which the tire is made. For example, in the United States, the design rims are as specified by the Tire and Rim Association. In Europe, the rims are as specified in the European Tyre and Rim Technical Organization—Standards Manual and the term design rim means the same as the standard measurement rims. In Japan, the standard organization is The Japan Automobile Tire Manufacturer's Association.

“Equatorial plane (EP)” means the plane perpendicular to the tire's axis of rotation and passing through the center of its tread;

“Innerliner” means the layer or layers of elastomer or other material that form the inside surface of a tubeless tire and that contain the inflating fluid within the tire;

“Normal rim diameter” means the average diameter of the rim flange at the location where the bead portion of the tire seats;

“Normal inflation pressure” refers to the specific design inflation pressure and load assigned by the appropriate standards organization for the service condition for the tire;

“Normal load” refers to the specific design inflation pressure and load assigned by the appropriate standards organization for the service condition for the tire;

“Ply” means a continuous layer of rubber-coated parallel cords;

“Radial” and “radially” mean directions radially toward or away from the axis of rotation of the tire;

“Radial-ply tire” means belted or circumferentially-restricted pneumatic tire in which the ply cords which extend from the bead to bead are laid at cord angles between 65 degrees and 90 degrees with respect to the equatorial plane of the tire;

“Section height” (SH) means the radial distance from the nominal rim diameter to the outer diameter of the tire at its equatorial plane; and,

“Section width” (SW) means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

### BRIEF DESCRIPTION OF DRAWINGS

The invention may take physical form and certain parts and arrangements of parts, several preferred embodiments of which will be described in detail in this specification and illustrated in the accompanying drawings which form a part whereof and wherein:

FIG. 1 is a cross-sectional view illustrating one side or one-half of a symmetrical heavy duty tire according to a first embodiment of the invention;

FIG. 2 is an enlarged cross-sectional view of the bead portion of the tire shown in FIG. 1;

FIG. 3 is an enlarged cross-sectional view illustrating the bead portion of a prior art tire;

FIG. 4 is an enlarged cross-sectional view of a second embodiment of a bead portion of the tire of FIG. 1;

FIG. 5 is an enlarged cross-sectional view of the bead portion of the tire of FIG. 2, shown with the tire mounted on the rim in an unloaded condition;

### DETAILED DESCRIPTION OF THE INVENTION

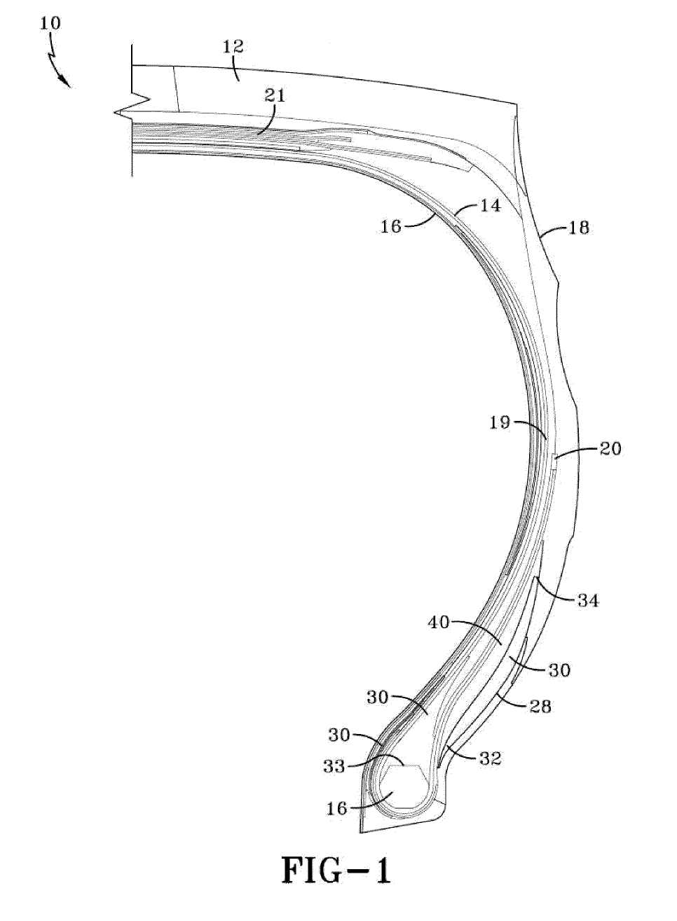

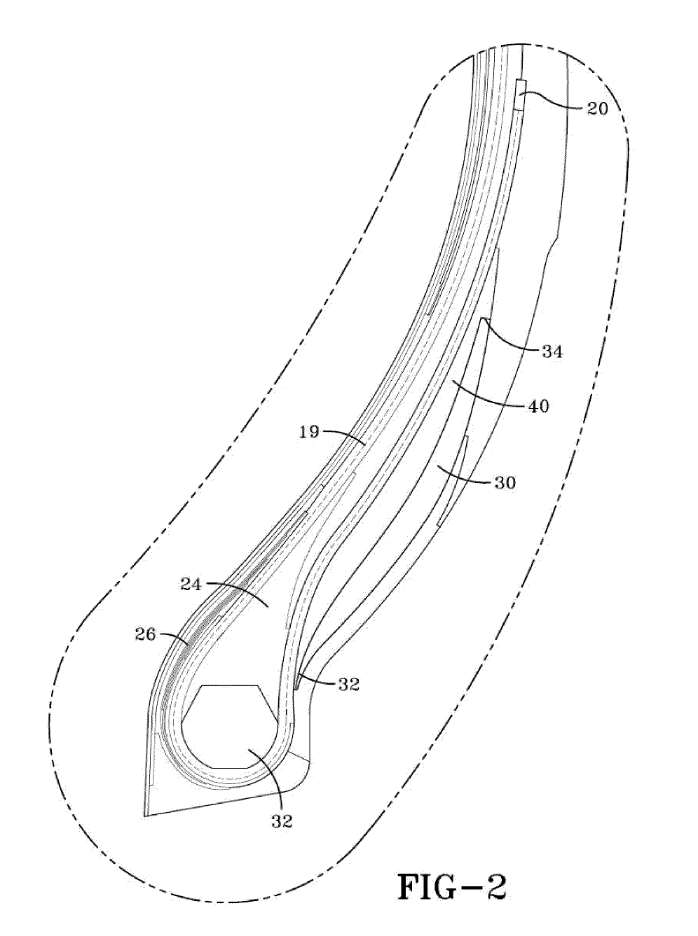

With reference to FIGS. 1 and 2, a cross-sectional view of one half of a tire of the present invention 10 is illustrated. The tire 10 has a carcass 14 which includes a crown region having a radially outer tread 12 disposed over the crown region of the carcass 14. The outer surface of the tread may further include a plurality of lands and grooves or a plurality of tread blocks and grooves, as commonly known to those skilled in the art. The carcass further includes an inner liner 16 that covers the entire interior facing surface of the tire carcass and serves to hold the air or gas mixture that is used to inflate the tire. The inner liner of the tire is typically made of butyl rubber. The carcass 14 further includes a pair of tire sidewalls 18 which extend radially inward from the outer radial surface of the of the tire carcass, terminating in the vicinity of a pair of inextensible beads 16.

The annular beads 16 illustrate an asymmetrical cross sectional shape having a lower half with a rounded outer surface and an upper half portion with angular outer edges similar to half of a hexagon. The annular beads may comprise other shapes such as, for example, round, hexagonal or a combination of shapes. Preferably, the radially innermost surface of the bead wire is rounded.

The carcass further includes one or more steel cord reinforced plies 19 are wrapped about each bead 16 forming a turn up 20, more preferably an envelope turnup. The one or more plies 19 are oriented in the radial direction. Disposed radially outwardly of the ply 19 in the crown area of the tire is a steel reinforced belt package 21 formed of two or more belts. A pair of sidewalls 18 extend radially inward from the tread 12 to the bead area. Located radially outward of the bead 16 is an elastomeric apex 24. The apex as shown may have a triangular cross-sectional shape. Wrapped around the bead 16 is a flipper 26. The flipper 26 is located adjacent the bead 16 and the carcass ply 19. Located on the axially inner edge of the bead area is a chafer 28.

A first turnup pad 30 is located adjacent the chafer 28 in the bead portion of the tire. The first turnup pad 30 has a first end 32 located in the vicinity of the bead wire 16, and more preferably in line with the radially outer surface 33 of the bead wire. The first turnup pad 30 has a second end 34 located between the first end 32 and the ply turnup 20. The length of the first turnup pad 30 is sized so that it is positioned over the 90 degree bend of the rim when the tire is under load. The first turnup pad 30 has a thickness in the range of about 10 to about 40 mm, and more preferably in the range of about 20 to about 30 mm. The length of the first turnup pad 30 may range from about 200 mm to about 400 mm. The first turnup pad 30 is comprised of an elastomeric or rubber material having a G′ which ranges from about 0.4. MPA to about 3 MPA. The first turnup pad 30 is made of a material having a G″ which ranges from about 0.05 MPA to about 0.5 MPA.

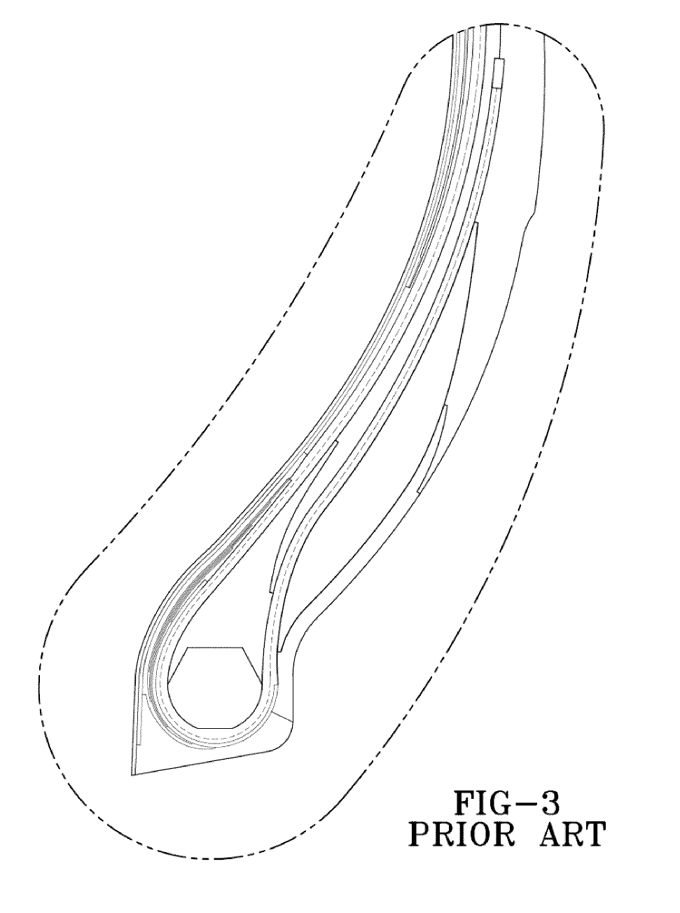

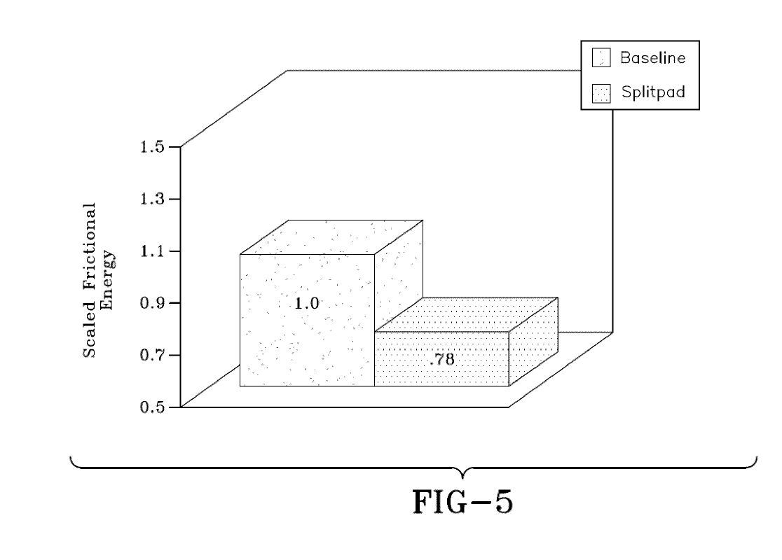

A second turnup pad 40 is located adjacent said first turnup pad 30, and is preferably located between the first turnup pad 30 and the ply 19. The second turnup pad 40 has a thickness in the range of about 15 to about 50 mm, and more preferably in the range of about 20 to about 35 mm. The length of the second turnup pad 40 may range from about 200 mm to about 500 mm. The second turnup pad 40 is comprised of an elastomeric or rubber material having a cured G′ which ranges from about 1 MPA to about 5 MPA. The second turnup pad 40 has a cured G″ which ranges from about 0.05 MPA to about 0.5 MPA. Thus it is desired that the first turnup pad 30 be about 40% to about 60% softer than the second turnup pad 40. As shown in FIG. 2, the length and thickness of the first turnup pad 30 is about the same or slightly smaller than the second turnup pad 40. A reduction in the stiffness of rubber of the first turnup pad 30 minimizes the tangential traction between the chafer 28 and rim thereby significantly reducing rim chafing. Finite element analysis of the invention has shown significant reduction in rim chafing. FIG. 5 illustrates the calculated accumulated frictional energy levels of the prior art turnup pad of FIG. 3 versus the accumulated frictional energy level of the split pad of FIG. 2. With the split pad embodiment, rim chafing between chafer and rim is reduced by 18-22%.

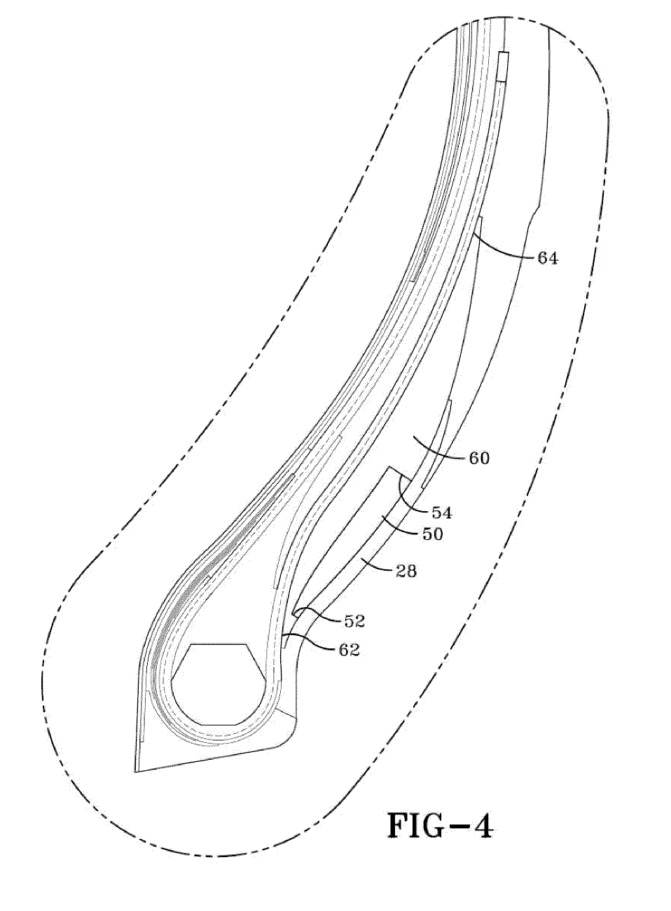

FIG. 4 illustrates an alternate embodiment of the invention wherein the first turnup pad 50 has a modified geometry. The first turnup pad is located in the region where the sidewall contacts the rim flange and has a robust thickness in the range of about 10 to about 40 mm. The first end 52 of the first turnup pad 50 is located radially outward of the bead, and has a second end 54 that is located radially inward of the outer tip of the apex. The remaining properties of the first turnup pad are as described, above. As shown in FIG. 4, the second turnup pad 60 is about twice as thick as the first turnup pad. The first turnup pad 60 has a first end 62 located about at the annular bead, and a second end 64 which extends radially outward of the apex tip and the second end 54 of the first turnup pad 50. The length of the second turnup pad is about twice the length of the first turnup pad.

What is claimed is:

1. A pneumatic tire comprising a carcass, the carcass having one or more cord reinforced plies and a pair of bead portions, each bead portion having at least one annular inextensible bead core about which the cord reinforced plies are wrapped, a tread and a belt reinforcing structure disposed radially outward of the carcass, the bead portion further comprising an apex which extends radially outward of the bead core, and a chafer, the tire further comprising a first turnup pad located adjacent said chafer, and a second turnup pad located adjacent said first turnup pad, and having a G′ less than the G′ of the second turnup pad.

2. The pneumatic tire of claim 1 wherein the thickness of the first turnup pad is about the same as the thickness of the second turnup pad.

3. The pneumatic tire of claim 1 wherein the length of the first turnup pad is about the same as the length of the second turnup pad.

4. The pneumatic tire of claim 1 wherein the second turnup pad is comprised of an elastomeric or rubber material having a cured G′ which ranges from about 1 MPA to about 5 MPA.

5. The pneumatic tire of claim 1 wherein the first turnup pad is comprised of an elastomeric or rubber material having a G′ which ranges from about 0.4 MPA to about 3 MPA.

6. The pneumatic tire of claim 1 wherein the first turnup pad is comprised of an elastomeric or rubber material having a G″ which ranges from about 0.05 MPA to about 0.5 MPA.

7. The pneumatic tire of claim 1 wherein the first turnup pad is comprised of an elastomeric or rubber material having a G″ which ranges from about 0.05 MPA to about 0.5 MPA.
